(19) United States
(12) Patent Application Publication
(10) Pub. No.: US 2007/0293089 A1
(43) Pub. Date: Dec. 20, 2007

(54) Fan, terminal seat of fan, and method of forming terminal seat

(75) Inventors: William Lu, Taoyuan Hsien (TW); Cheng-Shu Yu, Taoyuan Hsien (TW); Peng-Chu Tao, Taoyuan Hsien (TW); Ralf-Peter Fietz, Paderborn (DE)

Correspondence Address: BIRCH STEWART KOLASCH & BIRCH, PO BOX 747, FALLS CHURCH, VA, 22040-0747, US

(73) Assignee: DELTA ELECTRONICS INC.

(21) Appl. No.: 11/797,856

(22) Filed: May 8, 2007

(30) Foreign Application Priority Data
Jun. 15, 2006 (TW) 095121472
Jun. 15, 2006 (TW) 095121473
Jun. 15, 2006 (TW) 095121475

(51) Int. Cl. H01R 13/66

(52) U.S. Cl. 439/620.04

(57) ABSTRACT

A fan includes at least one rotor, a housing and at least one terminal seat. The rotor is disposed in the housing. The terminal seat includes a seat body and at least one knife-type terminal. The seat body is disposed on a circumference of the housing and has at least one terminal slot. The knife-type terminal is disposed in the corresponding terminal slot.

### CROSS REFERENCE TO RELATED APPLICATIONS

This Non-provisional application claims priority under 35 U.S.C. §119(a) on Patent Application Nos. 095121472, 095121473, and 095121475 both filed in Taiwan, Republic of China on Jun. 15, 2006, the entire contents of which are hereby incorporated by reference.

### BACKGROUND OF THE INVENTION

1. Field of Invention

The invention relates to a terminal seat, a fan frame and a method of connecting a terminal to a seat body, and, in particular, to a hot swapped terminal seat, a hot swapped fan frame and a method of connecting a terminal to a hot swapped seat body.

2. Related Art

With the enhancements in function and the operation speed of electronic systems, the heat generated by the electronic systems also increases. In order to make electronic systems work normally, the solution in the prior art is to provide a fan serving as a heat-dissipating device to provide an air stream forcing heat dissipation such that the electronic system can be kept at a normal temperature.

As shown in FIG. 1, a conventional fan 11 is connected to a system 14 (e.g., a mainboard or a circuit board) through a set of wires 12 to receive power and a driving signal to operate. The set of wires 12 is connected to the system 14 by way of bonding, or the set of wires 12 is connected to a terminal seat 13 having tubular terminals, and the terminal seat 13 is connected to the system 14. However, when the fan 11 is malfunction, the fan 11 cannot be replaced via the above-mentioned connection while the electronic system is in a state of continuous operation. In order to solve the above-mentioned problem, as shown in FIG. 2, a conventional fan 2, which may be hot swapped, may be directly swapped at the system end. The fan 2 includes a terminal seat 20 assembled on a fan frame 21 of the fan 2. The terminal seat 20 includes a seat body 201 and a plurality of terminals 202 projecting out of terminal holes 203 of the seat body 201. When the terminals 202 are moved radially on the fan 2, the fan 2 can be connected to the system end.

Because the terminals 202 project out in a radial direction, each of the terminals 202 must have a predetermined elasticity in order to enable the terminals 202 to be shifted radially, thereby restricting the thickness and the material of each of the terminals 202. This restriction not only increases the difficulty of inserting the terminals 202 into the terminal holes 203 but also increases the possibility of breaking the terminals 202, thereby reducing the yield in assembling.

### SUMMARY OF THE INVENTION

In view of the foregoing, the invention is to provide a fan, a terminal seat and a method of forming the terminal seat so as to reduce the possibility of breaking the terminals, enhance the connection intensity of the terminal and greatly increase the production and assembly yields.

To achieve the above, the invention discloses a fan including at least one rotor, a housing and at least one terminal seat. The rotor is disposed in the housing. The terminal seat includes a seat body and at least one knife-type terminal. The seat body is disposed on a circumference of the housing and has at least one terminal slot. The knife-type terminal is disposed in the corresponding terminal slot.

To achieve the above, the invention also discloses a fan including at least one rotor, a housing and at least one clamping-type terminal seat. The rotor is disposed in the housing. The clamping-type terminal seat includes a seat body and at least one pin. The seat body is disposed on a circumference of the housing and has at least one terminal slot. The pin is disposed in the corresponding first terminal slot. A contact of the pin extends in a non-radial direction of the fan.

To achieve the above, the invention discloses a knife-type terminal seat including a seat body and at least one knife-type terminal. The seat body has at least one terminal slot. The knife-type terminal is disposed in the corresponding terminal slot.

In addition, the invention discloses a method of forming a knife-type terminal seat. The method includes the steps of providing at least one knife-type terminal and a seat body having a terminal slot, correspondingly disposing the knife-type terminal into the terminal slot, and embedding a fixing portion of the knife-type terminal in the seat body.

To achieve the above, the invention also discloses a method of forming a knife-type terminal seat. The method includes the steps of providing at least one knife-type terminal, disposing the knife-type terminal in a mold, and forming a seat body in the mold with the knife-type terminal being embedded into the seat body.

As mentioned above, the terminal is designed as above-mentioned knife-type terminal or clamping-type terminal to enlarge the electrical contact surface area of the terminal, to enhance the intensity of the terminal, to prevent poor contact at the terminal and to provide the predetermined level of fixing force according to the fan, the terminal seat of the fan and the method of forming the terminal seat. Because the working surface of the knife-type terminal of the invention is different from the swapping direction, the thickness of the knife-type terminal is not restricted and the intensity of the knife-type terminal is higher, and the production and assembling yields of the terminal seat can be greatly increased. In addition, because the knife-type terminal of the invention has the plate-like structure, the knife-type terminal may be embedded in the seat body when the seat body of the terminal seat is being shaped. Thus, the connection intensity between the knife-type terminal and the seat body can be greatly increased, and the production yield and the production speed can be greatly increased.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a conventional fan connected to a system;

FIG. 2 is a schematic illustration showing a conventional fan, which may be hot swapped, and a terminal seat thereof;

FIG. 3 is a schematically exploded illustration showing a fan according to a preferred embodiment of the invention;

FIG. 4 is a schematic illustration showing a knife-type terminal according to a preferred embodiment of the invention;

FIG. 5 is a flow chart showing a method of forming a terminal seat according to a preferred embodiment of the invention; and

FIG. 6 is a flow chart showing a method of forming a terminal seat according to another preferred embodiment of the invention.

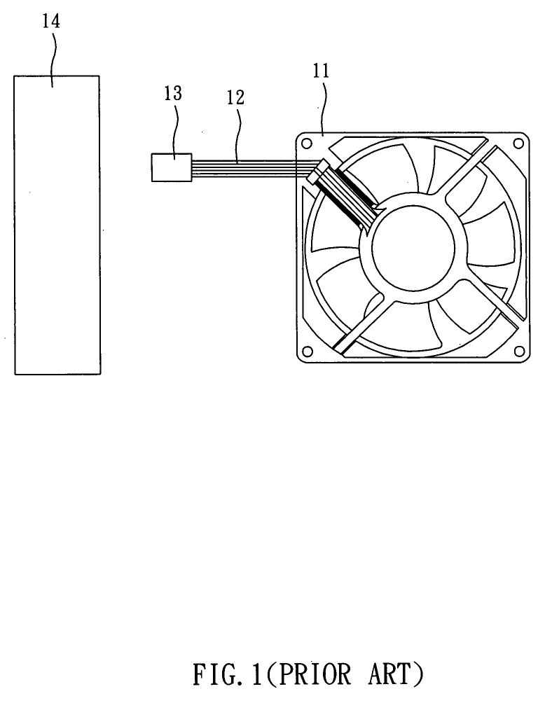

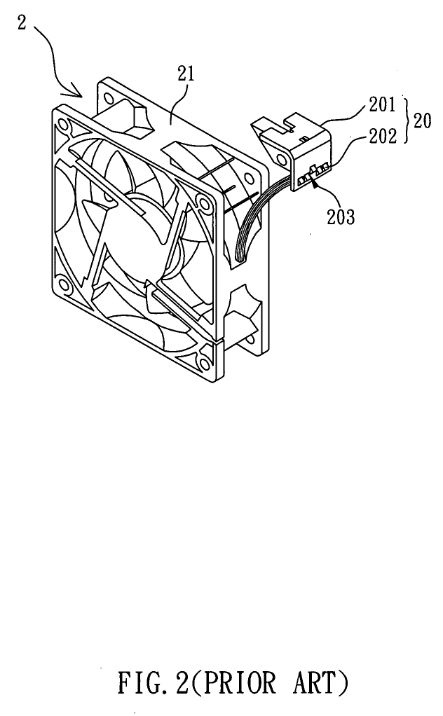

### DETAILED DESCRIPTION OF THE INVENTION

The present invention will be apparent from the following detailed description, which proceeds with reference to the accompanying drawings, wherein the same references relate to the same elements.

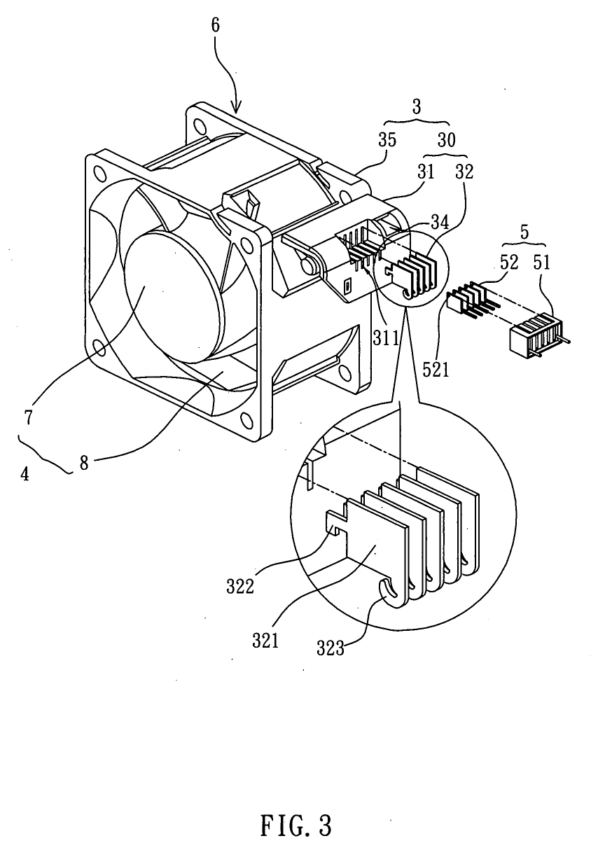

Referring to FIG. 3, a fan 6 according to a preferred embodiment of the invention includes a fan frame 3, a rotor 4 and a control device (not shown). The control device and the rotor 4 are accommodated in the fan frame 3. The control device, such as a driving circuit for the fan 6, controls the rotor 4 to rotate. The fan 6 may be a hot swap fan, for example. The rotor 4 has a hub 8 and at least one blade 7 disposed on a circumference of the hub 8. The blade 7 may be an axial-flow blade, a side-flow blade, a flat blade or a curved blade.

The fan frame 3 includes a frame body 35 and at least one terminal seat 30, which is connected to a circumference of the frame body 35 and is electrically connected to the control device. The terminal seat 30 includes a seat body 31 and at least one knife-type terminal 32.

The seat body 31 is connected to the circumference of the frame body 35 and has at least one terminal slot 311. The seat body 31 may be disposed at a corner of the frame body 35, on a sidewall of the frame body 35, or at any position of the frame body 35. In addition, the seat body 31 and the frame body 35 may be integrally formed as a single piece by injection molding, or may be assembled together. The seat body 31 may be designed to have different shapes according to the shape of the structure of the frame body 35. For example, the cross section of the seat body 31 may be flat, L-shaped or U-shaped. The seat body 31 may be made of the plastic material.

The knife-type terminal 32 is correspondingly disposed in the terminal slot 311. In this embodiment, the knife-type terminal 32 may have a flat structure, a curved structure, a U-shaped structure, an L-shaped structure or any other bent structure. The extending direction of the knife-type terminal 32 preferably conforms to the reaction direction of the terminal seat 30 such that the terminal seat 30 can be swapped with slight or no deformation of the knife-type terminal 32. Thus, the thickness of the knife-type terminal 32 of the invention may be far greater than that of the prior art terminal so as to possess greater intensity. So, when the terminals are assembled on the terminal seat, the terminals cannot be broken, and the production and assembly yields can be greatly enhanced.

In addition, when there are two or more than two knife-type terminals 32, the number of the terminal slots 311 is preferably equal to or greater than that of the knife-type terminals 32. As shown in FIG. 3, the knife-type terminals 32 disposed in the terminal slots 311 may be, without limitation, flush with each other, and the sizes, levels or orientations of the knife-type terminal 32 may be the same or different according to actual requirements.

Referring to FIG. 3, the knife-type terminal 32 has at least one body 321, a signal part 322 and a fixing portion 323. The signal part 322 is connected to the control device. The fixing portion 323 is provided to fix the knife-type terminal 32 in the seat body 31. In this embodiment, the body 321 or the signal part 322 may be electrically connected to the control device through, for example, at least one wire, and the fixing portion 323 may be an inverse hook. When the seat body 31 is being molded, the knife-type terminal 32 may be disposed in a shaping mold of the seat body 31. Therefore, the seat body 31 embeds at least the fixing portion 323, and the knife-type terminal 32 is fixed in the terminal slot 311. Alternately, the knife-type terminal 32 may also be inserted into the terminal slot 311 after the seat body 31 is molded, and then fixed in the terminal slot 311 via the fixing portion 323.

The body 321 is to be electrically connected to a clamping-type terminal seat 5 to receive signals transferred between the fan 6 and the clamping-type terminal seat 5. The signals may be, for example, a power signal, a driving signal, a warning signal, a state signal or the like. The body 321 is clamped by and electrically connected to the clamping-type terminal seat 5. The body 321 may have a flat structure, a curved structure, a U-shaped structure, an L-shaped structure or any other bent structure, for example.

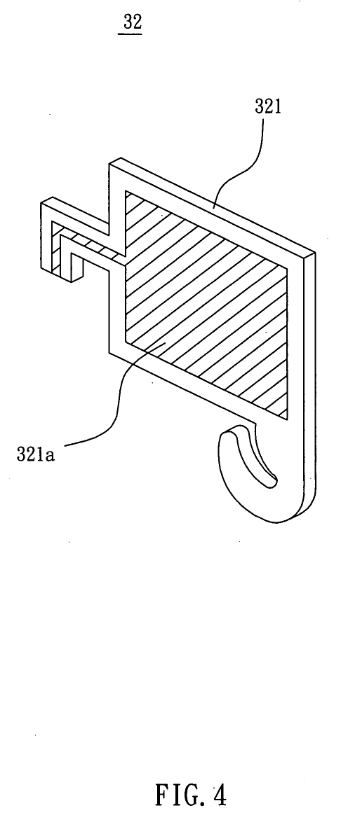

As shown in FIGS. 3 and 4, the body 321 and the signal part 322 may be made of a conductive material or a non-conductive material, such as a plastic material. When the body 321 or the signal part 322 is made of the non-conductive material, at least one side surface (e.g., plate-like surface) of the body 321 or the signal part 322 is formed with at least one conductive film 321a, which is electrically connected to the signal part 322 or the body 321 composed of the conductive material. The conductive film 321a may be partially embedded in the body 321 or the signal part 322, and may be only formed on the surface of the body 321 or the signal part 322. When the body 321 and the signal part 322 are made of non-conductive material, the conductive film 321a forms one conductive path, two conductive paths or more than two conductive paths on the body 321 and the signal part 322 simultaneously.

In addition, when there are two or more conductive films 321a, the conductive films may be formed only on the same surface of the body 321 or the signal part 322, on opposite surfaces of the body 321 or the signal part 322, or partially on the same surface and partially on the opposite surfaces.

In addition, the clamping-type terminal seat 5 corresponds to the seat body 31 and has at least one pin 52 and a seat body 51. The pin 52, which is accommodated in the seat body 51 and disposed corresponding to the body 321, is electrically connected to the body 321. The pin 52 may have, for example, an elastic structure, a bent structure or a structure with a protruding structure 521, wherein the protruding structure 521 preferably extends toward the inner wall or extends along a direction forming an angle relative to an extending surface of the pin 52. The body 321 or the conductive film 321a may be clamped by the pin 52 and the inner wall of the seat body 51 or clamped by multiple pins 52. Alternatively, the signal transmission amount can be increased by adjusting the number of pins 52 corresponding to the conductive films 321a so that the number of terminals can be greatly reduced, and the volume of the terminal seat can be reduced.

The clamping-type terminal seat 5 may be disposed on an external system housing, an interface card, a mainboard, a circuit board or any other external system. In addition, the embodiment is described according to the preferred but non-limitative example, in which the terminal seat 30 is disposed on the frame body 35, and the clamping-type terminal seat 5 is not disposed on the frame body 35. Instead, the clamping-type terminal seat 5 may be disposed on the frame body 35 but the terminal seat 30 is not disposed on the frame body 35. The contact at the middle section or the front end of the pin 52 of the clamping-type terminal seat 5 extends in a non-radial direction of the fan 6 or in a direction different from the extending direction of the knife-type terminal 32. Combining the knife-type terminal 32 of the terminal seat 30 with the clamping-type terminal seat 5 enables the fan 6 to be fixed to the external system with a predetermined level of fixing force without any other fixing structure.

In addition, the frame body 35 or the seat body 31 of the fan 6 may further have at least one hole 34 for accommodating a display (not shown), which may be a light emitting diode (LED), a laser diode (LD), an organic electroluminescent device (OELD) or a field emission device (FED). The hole 34 may be disposed at any position of the frame body 35 or on the seat body 31.

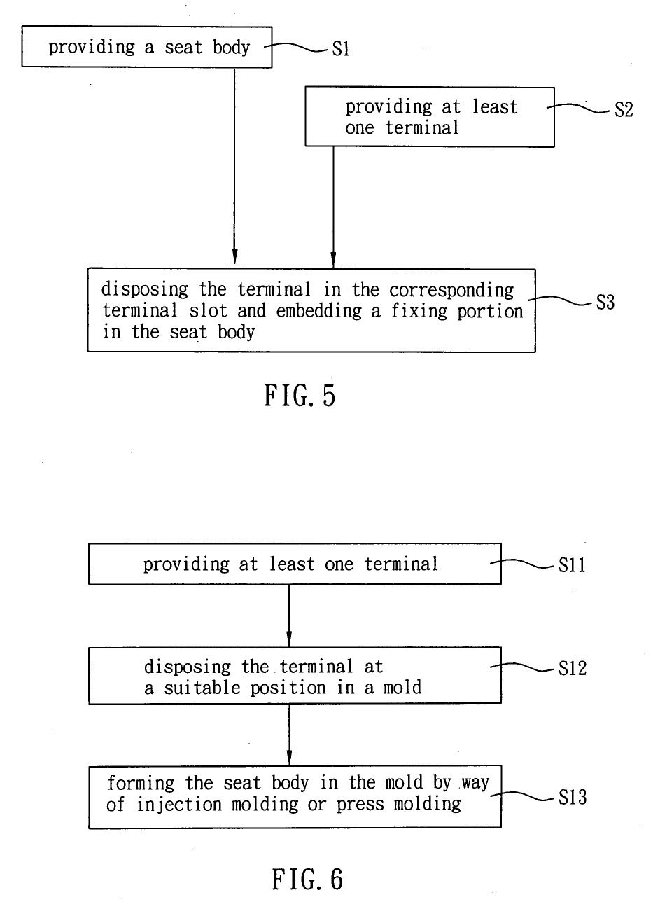

As shown in FIGS. 3 and 5, the method of forming the terminal seat of the invention includes the following steps. Step S1 provides a seat body 31 having at least one terminal slot 311. Step S2 provides at least one knife-type terminal 32. Step S3 disposes the knife-type terminal 32 in the corresponding terminal slot 311 and embeds the fixing portion 323 in the seat body 31.

In addition, as shown in FIGS. 3 and 6, the terminal seat of the invention may also be formed by the following steps. Step S11 provides at least one knife-type terminal 32. Step S12 disposes the knife-type terminal 32 at a suitable position in a mold. Step S13 forms the seat body 31 in the mold by way of injection molding or press molding. At this moment, the knife-type terminal 32 may also be fixed in the terminal slot 311 of the seat body 31.

Alternatively, when the terminal seat 30 of fan 6 of the invention is modified into the clamping-type terminal seat 5, the clamping-type terminal seat may be easily formed by this method by replacing the knife-type terminal 32 with the pin 52. When the seat body 31 or 51 is being formed, the seat body 31 or 51 and the frame body 35 may be integrally formed, or the seat body 31 or 51 may be formed and then combined with the frame body 35. The seat body may be made of a plastic material.

In summary, the terminal is designed as above-mentioned knife-type terminal or clamping-type terminal to enlarge the electrical contact surface area of the terminal, to enhance the terminal intensity, to prevent poor contact at the terminal and to provide the predetermined level of fixing force according to the fan, the terminal seat of the fan and the method of forming the terminal seat. Because the working surface of the knife-type terminal of the invention is different from the swapping direction, the thickness of the knife-type terminal is not restricted and the intensity of the knife-type terminal is higher, and the production and assembling yields of the terminal seat can be greatly increased. In addition, because the knife-type terminal of the invention has the plate-like structure, the knife-type terminal may be embedded in the seat body when the seat body of the terminal seat is being shaped. Thus, the connection intensity between the knife-type terminal and the seat body can be greatly increased, and the production yield and the production speed can be greatly increased.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A fan comprising:
at least one rotor;
a housing for containing the rotor therein; and
at least one terminal seat comprising a first seat body disposed on a circumference of the housing and having at least one terminal slot; and at least one knife-type terminal disposed in the corresponding terminal slot.

2. The fan according to claim 1, wherein the knife-type terminal is made of a conductive material.

3. The fan according to claim 1, wherein the knife-type terminal has a body and a signal part.

4. The fan according to claim 1, wherein the knife-type terminal has a fixing portion fixed to the first seat body, and the fixing portion is an inverse hook.

5. The fan according to claim 3, wherein the body or the signal part is made of a non-conductive material or plastic, and at least one conductive film is formed on at least one surface of the body or the signal part and disposed on the surface or partially embedded in the body or the signal part.

6. The fan according to claim 5, wherein a number of the conductive film is two or more, the conductive films are formed on the same surface of the body or the signal part, on opposite surfaces of the body or the signal part, or partially embedded in the body or the signal part, or partially disposed on the same surface and partially disposed on the opposite surfaces.

7. The fan according to claim 3, wherein the body or the signal part is electrically connected to a control device through at least one wire.

8. The fan according to claim 1 wherein the knife-type terminal has a flat structure, a curved structure, a U-shaped structure, an L-shaped structure or a bent structure.

9. The fan according to claim 1, wherein the first seat body has a flat cross section, an L-shaped cross section or a U-shaped cross section and is disposed at a corner or on a sidewall of a frame body.

10. The fan according to claim 1, wherein the first seat body and the frame body are integrally formed as a single piece or assembled together.

11. The fan according to claim 1, wherein the frame body or the first seat body has at least one hole for accommodating a display.

12. The fan according to claim 1, further comprising at least one clamping-type terminal seat, wherein the knife-type terminal is clamped by and electrically connected to the clamping-type terminal seat.

13. The fan according to claim 12, wherein the clamping-type terminal seat has at least one pin and a second seat body, and the knife-type terminal is clamped by the pin and the second seat body or clamped only by the pin.

14. The fan according to claim 13, wherein the pin has an elastic structure, a bent structure or a structure with at least one protruding structure extending toward an inner wall of the second seat body or along a direction forming an angle relative to an extending surface of the pin.

15. The fan according to claim 14, wherein a contact at a middle section or a front end of the pin extends in a non-radial direction of the fan or extends in a direction other than directly towards the knife-type terminal.

16. The fan according to claim 13, wherein the clamping-type terminal seat is disposed on an external system housing, an interface card, a mainboard, a circuit board or an external system.

17. The fan according to claim 1, wherein the terminal seat is formed by a method comprising steps of:
providing the first seat body having the terminal slot, and the knife-type terminal;
disposing the knife-type terminal into the terminal slot, correspondingly; and
embedding a fixing portion into the first seat body.

18. The fan according to claim 1, wherein the terminal seat is formed by a method comprising steps of:
providing the knife-type terminal;
disposing the knife-type terminal within a mold; and
forming the first seat body in the mold with the knife-type terminal embedded into the first seat body.

19. A fan comprising:
at least one rotor;
a housing for containing the rotor therein; and
at least one clamping-type terminal seat comprising a first seat body disposed on a circumference of the housing and having at least one first terminal slot;
and at least one pin disposed in the corresponding first terminal slot, wherein a contact of the pin extends in a non-radial direction of the fan.

20. The fan according to claim 19, wherein the pin has an elastic structure, a bent structure or a structure with at least one protruding structure extending toward an inner wall of the first seat body or along a direction forming an angle relative to an extending surface of the pin.

21. The fan according to claim 19, further comprising at least one knife-type terminal seat comprising a second seat body having at least one second terminal slot; and at least one knife-type terminal disposed on an external system housing, an interface card, a mainboard, a circuit board or an external system and disposed in the corresponding second terminal slot for being clamped by and electrically connected to the clamping-type terminal seat.

22. The fan according to claim 19, wherein the first seat body has a flat cross section, an L-shaped cross section or a U-shaped cross section and is disposed at a corner or on a sidewall of a frame body.

23. The fan according to claim 19, wherein the frame body or the first seat body has at least one hole for accommodating a display.

24. The fan according to claim 19, wherein the clamping-type terminal seat is formed by a method comprising steps of:
providing the pin and the first seat body having the first terminal slot;
correspondingly disposing the pin in the first terminal slot; and
embedding a fixing portion in the first seat body.

25. The fan according to claim 19, wherein the clamping-type terminal seat is formed by a method comprising steps of:
providing the pin;
disposing the pin within a mold, correspondingly; and
forming the first seat body in the mold with the pin embedded into the first seat body.

26. A knife-type terminal seat, comprising:
a first seat body having at least one terminal slot; and
at least one knife-type terminal disposed in the corresponding terminal slot.
